(19) United States
(12) Patent Application Publication
(10) Pub. No.: US 2005/0246220 A1
(43) Pub. Date: Nov. 3, 2005

(54) System and method for optimizing the cost of buying and selling electrical energy

(75) Inventors: John Thomson, Toronto (CA); Rolfe Philip, Toronto (CA); David Richards, Toronto (CA)

Correspondence Address: DIMOCK STRATTON LLP, 20 QUEEN STREET WEST SUITE 3202, BOX 102, TORONTO, ON, M5H 3R3, CA

(73) Assignee: NRGen Inc.

(21) Appl. No.: 10/835,268

(22) Filed: Apr. 30, 2004

(51) Int. Cl. G06F 17/60

(52) U.S. Cl. 705/10; 705/1; 705/37

(57) ABSTRACT

The invention provides a system and method for optimizing the cost of buying and price for selling electrical energy by forecasting the price from a plurality of sources of electrical energy for a plurality of time intervals within a set time period, determining an optimum time within the set time period for purchasing or selling electrical energy, and implementing the purchase or sale of electrical energy at the optimum time.

### FIELD OF THE INVENTION

The invention relates to a system and method for optimizing the cost of buying and selling electrical energy, in particular, to a system and method for minimizing the cost of consumer use of electrical energy and maximizing the price obtained by producers and distributors of electrical energy for supplying electrical energy generated through small-scale and on-site electrical energy generation means in deregulated markets.

### BACKGROUND OF THE INVENTION

Consumers of electrical energy in deregulated markets are required to pay market prices for their electrical energy usage. While energy prices fluctuate on a daily basis, consumers do not have a means to control the price of the electrical energy they consume.

Various organizations have tried to control cost spikes in consumer usage of electrical energy with energy management systems that aim to reduce overall energy consumption by controlling the incoming electrical energy flow to ensure maximum efficiency from equipment. However, none of these systems take the current market price of electrical energy into account.

Producers of electrical energy in deregulated markets also receive the current market price for energy generated. For certain electrical energy generation means, such as wind and solar, the price obtained at time of generation may not be optimal given the cost of production. Small-scale producers faced with higher costs of production than large-scale producers have difficulty obtaining a profit on their output production. No automated method exists for optimizing the time of production based on the current market conditions.

Some energy generators have implemented a form of electrical energy storage by means such as lead acid batteries. However, there exists no automated method for optimizing the use and sale of this stored electrical energy based on current market conditions. Storage is used either on a preset schedule or through manual intervention.

Distributors of electrical energy in deregulated markets distribute electrical energy to end users based on the demand for electrical energy within their region. Distributors with their own electrical energy generation capabilities are also producers of electrical energy and have difficulty identifying the optimal time to generate power to maximize their profit. No automated method exists for optimizing the time of production against the current market conditions.

Some of these distributors have implemented or are considering some form of electrical energy storage, including fuel cells with hydrolyzers and pumped water storage. However, there exists no automated method for determining the most preferred times to store, use and sell electrical energy based on current market conditions. Stored electrical energy is currently used either on a preset schedule or through manual intervention.

There therefore remains a need for a system and method that facilitates the usage and sale of electrical energy under optimal market conditions.

### SUMMARY OF THE INVENTION

The present invention provides a system and method for minimizing the cost of electrical energy usage and maximizing the price for electrical energy generated through small-scale and on-site electrical energy generation means.

The invention provides a system for optimizing the cost of buying and price for selling electrical energy comprising the following components: a forecasting means for forecasting prices from a plurality of sources of electrical energy for a plurality of time intervals within a set time period; an optimizing means for determining an optimum time within the set time period for purchasing or selling electrical energy; and, a work flow means for implementing the purchase or sale of electrical energy at the optimum time.

In one embodiment of the invention, it provides a method for optimizing the cost of buying and price for selling electrical energy using the system where the method comprises the steps of: forecasting prices from any number of sources of electrical energy for a plurality of time intervals over a set time period; determining an optimum time within the set time period for purchasing or selling electrical energy; and, implementing the purchase or sale of electrical energy at the optimum time.

In another embodiment of the invention, there is provided a method for optimizing the cost of buying electrical energy using the system, where the method comprising the steps of: forecasting a most preferred cost and source of energy for a consumer for a plurality of time intervals over a set time period; determining an optimum time within the set time period for purchasing electrical energy; and, implementing the purchase of electrical energy at the optimum time at the most preferred cost from the most preferred source.

In a further embodiment of the invention, there is provided a method for optimizing the price for selling electrical energy using the system where the method comprises the steps of: forecasting a most preferred price and source for generating electrical energy for a plurality of time intervals with a set time period; determining a first optimal time within the set time period for generating electrical energy at the most preferred cost and determining a second optimal time within the set time period for selling the generated electrical energy; implementing the generation of electrical energy at the first optimal time; and, implementing the sale of the generated electrical energy at the second optimum time.

In preferred embodiments of the invention, the electrical energy purchased or generated at low costs can be stored for use or sale when the market prices of electrical energy are high.

The present invention has many advantages. The system and method of the present invention can minimize a consumer's costs of purchasing electrical energy by maximizing the purchase of electrical energy when the cost is low. The present invention will also help consumers manage their electrical energy usage through daily price fluctuations.

The system and method of the present invention can also maximize a producer's profits from the sale of electrical energy by generating electrical energy when prices are low and selling electrical energy when prices are high.

Various other advantages will be apparent to the person skilled in the art from the following description of the present invention read in conjunction with the accompanying drawings. It will be apparent to the person skilled in the art that not every embodiment of the invention will achieve all of the advantages of the invention.

### DESCRIPTION OF THE DRAWINGS

In drawings which illustrate by way of example only preferred embodiments of the invention:

FIG. 1 is a schematic drawing of a preferred embodiment of the invention directed at optimizing the cost for electrical energy usage.

FIG. 2 is a schematic drawing of a preferred embodiment of the invention directed at maximizing the profit from producing electrical energy.

### DETAILED DESCRIPTION OF THE INVENTION

The present invention provides a system and method for optimizing the cost of buying and price for selling electrical energy by identifying when electrical energy should be bought, sold, stored and generated. The method of the present invention provides advantages to consumers, producers and distributors of electrical energy.

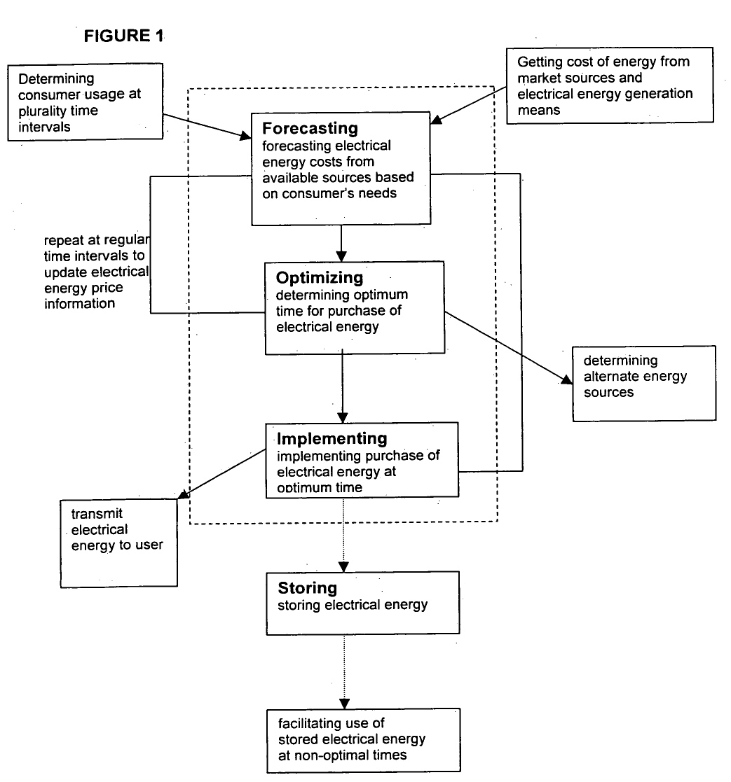

Referring to FIG. 1, the present invention appears in the dashed lines and provides a system and method that forecasts the cost of electrical energy at different time intervals from market sources and electrical energy generation means based on a consumer's needs, determines when it is cost effective to purchase electrical energy, and implements the purchasing strategy while maintaining a constant supply of electrical energy for the consumer.

In this embodiment of the invention, a data manager such as a neural network is used to gather information about the cost of electrical energy from all of its available sources at a given time during a given day and to gather information about the consumer's usage needs at that given time during that given day. It will be apparent to the person skilled in the art that energy is available from a variety of electrical energy generation means, including market networks and local generation sources, including solar energy, wind power, biomass and natural gas and diesel generators/turbines. The information gathered will include data about the price of each of these electrical energy generation means.

Information regarding the cost of energy may be obtained from any number of sources. In a preferred embodiment of the invention, information regarding the planned cost of market-sourced electrical energy is obtained from the internet on the basis of prices set twenty-four hours in advance by independent market organizations based on consumer supply and demand. The actual cost is a real-time price that is obtained every five minutes. In most deregulated markets, the prices are predicted by the market twenty-four hours in advance on an hour-by-hour basis. The market prices are captured through real-time spot markets in five-minute increments. In most markets, the real-time prices are then averaged over the hour and presented as the electrical energy amount on a billing to consumers.

Information regarding the cost of on-site generated energy, including solar energy, wind power and natural gas and diesel generators/turbines is calculated from published data on fuel prices and from operational costs of wind power, solar power and other forms of energy calculated at certain times of the year.

Information regarding a consumer's necessary usage at a given time during a given day is determined from historical usage data and a consumer profile is recorded in the system during setup. If an energy management system (EMS) is in place, updated profile information will be captured from the EMS through available Application Programming Interfaces (APIs) to supplement available information. It will be apparent to a person skilled in the art that where the consumer includes more than one entity, a processing system can be used to aggregate the requirements for the collective group.

As information regarding energy costs and consumer usage is gathered, the forecasting system uses a neural network to determine the cost for each electrical energy generation means for every hour in the day.

This information is then fed into an optimizing engine, which is directed at evaluating the lowest cost of energy for the consumer. The optimizing engine determines when the consumer should buy electrical energy during the day based on cost. Where costs of electrical energy are low, the optimizing engine may direct that additional electrical energy be purchased and that a portion of that electrical energy be stored for later consumption during the day when the cost of electrical energy is high. The electrical energy may be stored using a hydrolyser and fuel cells, regenerative fuel cells, super capacitors or any other like means. Where the cost of electrical energy is high, the optimizing engine may direct that energy from other on-site sources—i.e. solar energy, wind energy, natural gas—be used instead of market generated electrical energy, or that the stored energy be consumed. Where the stored energy is consumed, the optimizing engine will direct that the energy source be switched to the stored energy.

In a preferred embodiment, the optimizing engine uses dynamic programming. The optimizing engine decomposes the optimization task into a finite number of stages, and uses a neural network of similar situations to derive the optimal price points for the planned prices in a day. Each stage contains the same set of discrete objects under consideration (a list of alternative energies and their associated price points). The cost of combining each item in the set, with the set of best combinations computed from the previous stage is computed. Using the principle of optimality, only the best combinations are saved, and the process repeats itself periodically, for example each hour until the last stage is reached. The final set of best combinations, or strategies, is then examined. The optimal solution is the one that provides the minimal cost for the day, based on capabilities to store, use and store, or use, in whole or in part, with one or a number of sources of electrical energy and storage systems.

The output from the optimizer engine drives a workflow engine where the directions for energy consumption are implemented. The workflow engine sends messages to remote agents and switches to access the electrical energy sources. The workflow engine communicates with external energy management systems to coordinate equipment, required start-ups, and shut-downs.

The method of the present invention may be repeated every hour to accommodate for the hourly reporting of updated electrical energy prices.

It will be apparent to a person skilled in the art that where the consumer employs discrete, individually metered electrical equipment, the invention can be used to calculate accurate electrical energy costing for the equipment's operation. For example, hydrogen fueling stations generating hydrogen for fuel from electrical energy drawn from market sources can leverage the pricing information captured in the system to calculate accurate costing for the stored hydrogen.

In a second embodiment of the invention, the system and method of the present invention can be used to maximize the profit obtained from selling electrical energy. In this embodiment, the present invention provides a system and method that forecasts the price of energy from market sources, determines when it is economically effective to sell electrical energy, and implements the selling strategy while directing the use of electrical energy storage and generation. It will be apparent that this embodiment of the invention may be more useful for producers of electrical energy for determining the optimal price for selling electrical energy.

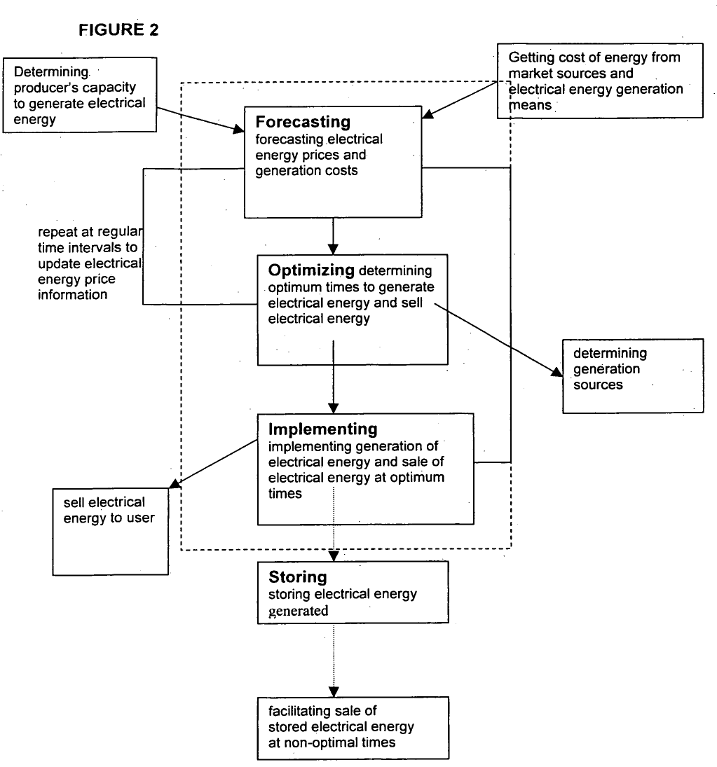

Referring to FIG. 2, in this embodiment the neural network is used to gather information about the price of market-sourced electrical energy, the cost of generating electrical energy from energy sources such as solar energy, wind power and natural gas and diesel generators/turbines, and the producer's capacity to generate electrical energy, at a given time during the day.

Information regarding a producer's capacity at a given time during the day is determined from historical production data and from forecasting external factors such as weather and fuel prices. From this data, a customer profile is created within the neural network. It will be apparent to a person skilled in the art that where the producer includes more than one entity, a processing system can be used to aggregate the requirements for the collective group so that the customer profile is reflective of the collective.

As information regarding energy prices and production capacity is gathered, the forecasting system uses the neural network to determine the price of energy on the market for every hour in the day.

This information is then fed into the optimizing engine, which is directed at determining when the producer should sell electrical energy during the day based on price. Where prices of electrical energy are low, the optimizing engine may direct that additional electrical energy be generated and that a portion of that electrical energy be stored for sale later in the day when the price of electrical energy is high. The electrical energy may be stored using any number of means, including but not limited to hydrolyser and fuel cells, regenerative fuel cells, and super capacitors.

The output from the optimizer engine drives the workflow engine where the directions for energy production and sale are implemented. The workflow engine sends messages to remote agents and switches to coordinate equipment, required start-ups, and shut-downs.

The method of the present invention may be repeated every hour to accommodate for the hourly reporting of updated electrical energy prices.

It will also be apparent to the person skilled in the art that distributors of electrical energy may use the present invention to optimize both the cost for buying electrical energy and the price for distributing electrical energy.

In this embodiment of the invention, the neural network is used to gather information about the price of energy, the distributor's market needs, and the distributor's generation capacity, at a given time during the day. Information regarding a distributor's market needs and generation capacity at a given time during the day is determined from historical production data and by forecasting external factors such as weather and fuel prices. From this data, a distributor profile is created in the neural network. The distributor's profile represents the requirements for a collective group represented by the distributor's customer base.

As information regarding energy prices, demand and production capacity is gathered by the neural network, the forecasting system uses the neural network to determine the price and demand for electrical energy on the market for every hour in the day.

This information is then fed into the optimizing engine, which is directed at evaluating the optimal price for energy for distributor at a given time during the day. The optimizing engine determines when the distributor should buy, sell, produce, and store electrical energy during the day based on price.

The output from the optimizer engine drives the workflow engine where the directions for energy purchases, energy production and energy sale are implemented. The workflow engine sends messages to remote agents and switches to coordinate equipment, required start-ups, and shut-downs. Further, directions can be provided for distributors to instruct their own customers on when to buy, when to sell, when to store and when to produce electrical energy. The method may be repeated every hour to accommodate for the hourly reporting of updated electrical energy prices.

It will be apparent to the person skilled in the art that the system and method of the present invention can also be used as an electrical energy trading system. In this embodiment, the neural network is used to gather information about the price and demand for energy on the market at a given time during a the day and to gather information about the electrical energy trader's storage capacity and stored energy cost at that given time during that given day.

The information gathered by the neural network is fed into an optimizing engine, which is directed at evaluating the optimal price for energy for the trader at a given time during the day. The optimizing engine determines when electrical energy should be bought, stored and sold during the day based on price. Where prices of electrical energy are low, the optimizing engine may direct that electrical energy be bought and stored for sale later in the day when the price of electrical energy is high. The electrical energy may be stored using a hydrolyser and fuel cells, regenerative fuel cells, super capacitors or any other like means.

The optimizing engine directs the switches to control the flow of electricity. The switch is coordinated with the market to control system-wide supply to ensure compliance.

From the various embodiments of the present invention having thus been described in detail by way of example, variations and modifications will be apparent to those skilled in the art. The invention includes all such variations and modifications as fall within the scope of the appended claims.

1. A system for optimizing the cost of buying and price for selling electrical energy comprising the following components:
(a) a forecasting means for forecasting prices from a plurality of sources of electrical energy for a plurality of time intervals within a set time period;
(b) an optimizing means for determining an optimum time within the set time period for purchasing or selling electrical energy; and,
(c) a work flow means for implementing the purchase or sale of electrical energy at the optimum time.

2. A method for optimizing the cost of buying and price for selling electrical energy using the system of claim 1 comprising the steps of:
(a) forecasting prices from a plurality of sources of electrical energy for a plurality of time intervals within a set time period;
(b) determining an optimum time within the set time period for purchasing or selling electrical energy; and,
(c) implementing the purchase or sale of electrical energy at the optimum time.

3. A method for electrical energy usage optimization using the system of claim 1 comprising the steps of:
(a) forecasting a most preferred cost and source of energy for a consumer at a plurality of time intervals within a set time period;
(b) determining an optimum time within the set time period for purchasing electrical energy;
(c) implementing the purchase of electrical energy at the optimum time at the most preferred cost from the most preferred electrical energy source.

4. A method for optimizing the price for selling electrical energy using the system of claim 1 comprising the steps of:
(a) forecasting a most preferred price for selling electrical energy and a most preferred cost for generating electrical energy at a plurality of time intervals within a set time period;
(b) determining a first optimal time within the set time period for generating electrical energy at the most preferred cost and determining a second optimal time within the set time period for selling electrical energy at a most preferred price;
(c) implementing the generation of electrical energy at the first optimal time; and,
(d) implementing the sale of the generated electrical energy at the second optimum time.

5. The method of claim 2 wherein the step of forecasting involves determining the cost of energy from market sources and at least wind, solar, biomass and natural gas diesel generator/turbine electrical energy generation means.

6. The method of claim 3 wherein the step of forecasting involves determining the cost of energy from market sources and at least wind, solar, biomass and natural gas diesel generator/turbine electrical energy generation means.

7. The method of claim 4 wherein the step of forecasting involves determining the cost of energy from market sources and at least wind, solar, biomass and natural gas diesel generator/turbine electrical energy generation means.

8. The method of claim 2, wherein the step of forecasting further includes determining the consumer's energy usage for a plurality of time intervals within a set period of time.

9. The method of claim 3 wherein the step of forecasting further includes determining the consumer's energy usage for a plurality of time intervals within a set period of time.

10. The method of claim 2 wherein the step of forecasting further includes determining a producer's capacity to generate electrical energy.

11. The method of claim 4 wherein the step of forecasting further includes determining a producer's capacity to generate electrical energy.

12. The method of claim 3 wherein the most preferred cost of purchasing electrical energy is when the price is low and the most preferred cost of selling electrical energy is when the price is high.

13. The method of claim 4 wherein the most preferred cost of purchasing or generating electrical energy is when the price is low and the most preferred cost of selling electrical energy is when the price is high.

14. The method of claim 2 comprising the further step of storing at least a portion of the electrical energy purchased for use at a time when the electrical energy is at a high cost.

15. The method of claim 3 comprising the further step of storing at least a portion of the electrical energy purchased for use at a time when the electrical energy is at a high cost.

16. The method of claim 4 comprising the further step of storing at least a portion of the electrical energy purchased or generated for use at a time when the electrical energy is at a high cost.

17. The method of claim 16 comprising the further step of facilitating the use or sale of the stored electrical energy at the time when the energy is at a high cost.

18. The method of claim 4 wherein step (a) is repeated at least every hour thereby causing step (b) to be updated with every repeat.

19. The method of claim 4 wherein the set time period is twenty-four hours and the time intervals are one hour apart.
